(19) United States
(12) Patent Application Publication
(10) Pub. No.: US 2004/0036912 A1
(43) Pub. Date: Feb. 26, 2004

(54) Method and system for accessing documents in environments with limited connection speed, storage, and screen space

(76) Inventors: Shih-Ping Liou, West Windsor, NJ (US); Michelle Yan, Plainsboro, NJ (US)

Correspondence Address: Siemens Corporation, Intellectual Property Department, 186 Wood Avenue South, Iselin, NJ, 08830, US

(21) Appl. No.: 10/223,840

(22) Filed: Aug. 20, 2002

(51) Int. Cl. B41F 1/00; G06K 1/00; G06F 15/00

(52) U.S. Cl. 358/1.16; 358/1.15; 358/1.2

(57) ABSTRACT

This invention is related to remote document access. More specifically, mobile device users are provided with the ability to easily access remote documents over a network such as the Internet, and to quickly view the content without resorting to a local download. By introducing streaming-on-demand and dividing the page into smaller segments, the invention significantly reduces bandwidth usage and speeds up the complete viewing process, since only data corresponding to the active viewing window is transmitted. As a result, resources are effectively utilized, and users seamlessly view documents. Moreover, users are able to easily identify documents by viewing thumbnails of original layouts and/or reading document content with an image quality that is very close to what is on their desktop. Without downloading the complete document onto a mobile device, this invention allows a mobile user to approve or forward the document to coworkers, and to print or fax the document on a nearby printer or fax machine.

### FIELD OF THE INVENTION

The present invention relates generally to remote document access, and, more particularly, to techniques for providing mobile device users with the ability to remotely access documents and to remotely print or fax documents.

### BACKGROUND OF THE INVENTION

Corporate employees spend more time than ever working away from their offices. However, it is often difficult to be fully productive while on the road. For instance, necessary documents may be stored at the office and these documents may not be available at a remote location or access to these documents may be inconvenient.

To increase productivity, it would be desirable to have employees stay connected and perform as many office tasks as possible. For example, an employee waiting at an airport should be able to access corporate documents and quickly identify a document, read the document and further make prompt decisions, such as approving or forwarding the document to coworkers.

Other mobile device users could also benefit from being able to remotely access documents. For example, physicians may wish to remotely access patient hospital records (e.g., X-ray images, CAT scans or lab reports) to determine further treatment or change prescriptions. Currently, physicians do not have convenient access to these records from their offices.

Several products already exist for mobile users to access documents. For example, MICROSOFT POCKET OFFICE allows documents to be transferred onto a mobile device, compressed and converted. However, it is not realistic to expect users to know what documents to copy onto their mobile device before they leave for the road. In many cases, the documents were not ready when the user left the office, or it may be impossible to store the entire file on the device. Remote access may also still be needed to provide updated information.

Some devices available in the market have been developed for remote document access. The POCKET INTERNET EXPLORER (POCKET IE) is such an example. However, techniques such as text re-flowing and reformatting are used to fit the content to the display screen. Hence, these techniques change the look and feel of original documents, making them difficult to be recognized and undesirable to be used for approval purposes.

Another product is NETVUE from AccuSoft Corporation which offers remote document viewing, collaboration and printing via the World Wide Web (WWW) for desktop application. Documents are addressed using the NetVue Document Streaming (NDS) technology. Since NDS is targeted, the minimum data handled at a time corresponds to the entire content of each page. However, mobile users do not have the luxury of desktop users because of their limited computing environment and reliance on network resources, making this technology unsuitable for mobile users.

The services provided by GOAMERICA and PRINTERON offer the ability to access remote documents. However, the content of a text document can only be read or viewed through fax or email, supported document formats are limited, and the original layout is not preserved.

Accordingly, it would be desirable and highly advantageous to have a technique for providing mobile device users with the ability to remotely access documents and to print or fax documents that avoids the problems associated with conventional methods.

### SUMMARY OF THE INVENTION

The present invention provides mobile device users with the ability to remotely access documents. The invention allows mobile users to quickly identify documents and seamlessly view their content with minimum delay and network usage as well as limited storage requirement.

By introducing streaming-on-demand and dividing the page into smaller segments, it significantly reduces bandwidth usage and speeds up the complete viewing process, since only data corresponding to the active viewing window is transmitted. As a result, resources are effectively utilized, and users seamlessly view documents. Moreover, users are able to easily identify documents by viewing thumbnails of original layouts and/or reading document content with an image quality that is very close to what is on their desktop. Without downloading the complete document onto a mobile device, this invention allows a mobile user to approve or forward the document to coworkers, and to print or fax the document on a nearby printer or fax machine.

According to various embodiments of the present invention, there is provided a method for remotely accessing documents stored in a document repository. The method includes requesting a list of documents from the document repository. The list of documents is presented to a user in a manner enabling identification of documents and selection of a particular document from the list (e.g., by using thumbnails). As the user browses a selected document, streamed data corresponding to specified portions of the selected document are received. The specified portions of the selected document are then displayed on the client device. Advantageously, the displayed portions of the selected document retain the look and feel of corresponding portions of the document stored in the document repository.

The user may employ various means for specifying portions of the selected document. For example, a stylus may be used to drag a desired portion of the document into the current active window. A hand tool may also be employed to pan the viewable information associated with the document. Also, a scroll bar may be used to move data in the window to view a portion of the document. Scrolling may be controlled by a mouse, arrow keys, or another means. A zoom tool may be employed to increase or decrease the resolution of the viewable information. In addition to these means, a particular page or section of a document (e.g., page 15) may be specified enabling direct retrieval of this portion of the document from the document repository.

Unlike with conventional streaming, streamed data is not necessarily received according to a specific time line. In the approach of the present invention, streamed data can be sent in any order and at least some data may be re-sent to the client device.

The documents stored in the document repository may be stored as private folders on a server. Viewable documents have no size limitation at all because they do not need to be completely downloaded to the client device. The client device may be a mobile device such as a Personal Digital Assistant (PDA). The mobile device may access a network via dial-up modem or be connected to a wireless network, for example.

The method for providing remote access may further include determining a current active window of a client device, obtaining a portion of the selected document corresponding to the active window, and sending streamed data corresponding to the portion of the selected document. These steps may be repeated as the user browses the document and uses various navigation features.

Information that is expected to be requested by a client may be placed into a data queue. The specified portions of the selected document may include information obtained from this data queue. Furthermore, data may be removed from the data queue that is no longer expected to be used.

The method may further include the steps of receiving a request to provide a hard copy of a document stored in the document repository to a selected output device, and sending the requested document to the selected output device.

The selected output device may be a facsimile (fax) machine or a printer. Optionally, the printer may be provided by a third party service provider via the Internet.

The method may further include processing a request to change the status of a document stored in the document repository. For example, a user may change the status of a document to ‘approved’ or ‘disapproved’.

These and other aspects, features and advantages of the present invention will become apparent from the following detailed description of preferred embodiments, which is to be read in connection with the accompanying drawings.

### BRIEF DESCRIPTION OF THE DRAWINGS

FIGS. 1 and 2 illustrate an overall system flow in accordance with various embodiments of the present invention;

FIG. 3 illustrates the functioning of the document streaming server of FIGS. 1 and 2;

FIG. 4 illustrates the functioning of the document viewer of FIGS. 1 and 2; and

FIG. 5 depicts the integration of a third-party printing service with an embodiment of the present invention.

### DETAILED DESCRIPTION OF PREFERRED EMBODIMENTS

A streaming-on-demand mechanism is one key aspect of the invention, where both the client and server are involved. On the server side, focus is on transmitting only the essential data (e.g., portion of a page) and only when it is needed. Hence, the server must keep track of where the active viewing area is to avoid transmitting excessive data. This mechanism requires significantly less bandwidth than conventional streaming. Additionally, the transmission rate may be dynamically adjusted and also data packets may be discarded or removed according to client feedback.

On the client side, the present invention monitors all client requests and server responses, and informs the server about the client's present status and any user decisions. For example, once an active viewing area is moved, position information is immediately sent back to the server to request additional data. If a delay is detected between a particular request and the arrival of corresponding data packets, the server can be informed as what to do next. Further, since only a relatively small amount of data is processed at a time, the client application effectively utilizes device resources, and offers mobile users the ability to view each requested portion of content almost immediately even with a low bandwidth connection.

The streaming-on-demand feature of this invention requires much lower bandwidth than what is required by live streaming, although it works in much the same way as live streaming. Small packets of data are sent to the client to be viewed. Packets are sent only when requested, for example, by tapping and dragging a screen. Only the packets of data corresponding to the current viewing area are sent for display. Therefore, unlike live streaming, a client can request the very same packets of data more than once.

Another important aspect of the invention is the ability to preserve the original look and feel of each document when presented to users, which facilitates document recognition and the approval process with minimum bandwidth usage. Specifically, the content of each page is transmitted either on a page-by-page basis using thumbnails of an original document or on-demand for an active viewing area with the original fidelity, using a document streaming-on-demand mechanism. Once the thumbnail or the original look and feel of a page is presented on a device, the original layouts can be immediately identified, along with the corresponding document.

These features greatly improve the ability for quick document identification. Furthermore, the original look and feel display offers a high quality image and resolution that is close to what is on the desktop, so that users can view or read details of the content, if necessary. Or, as an alternative to reading on a small screen, the system may provide an Internet printing service that enables the document to be printed or faxed to any subscribed Internet printer via a global printer directory.

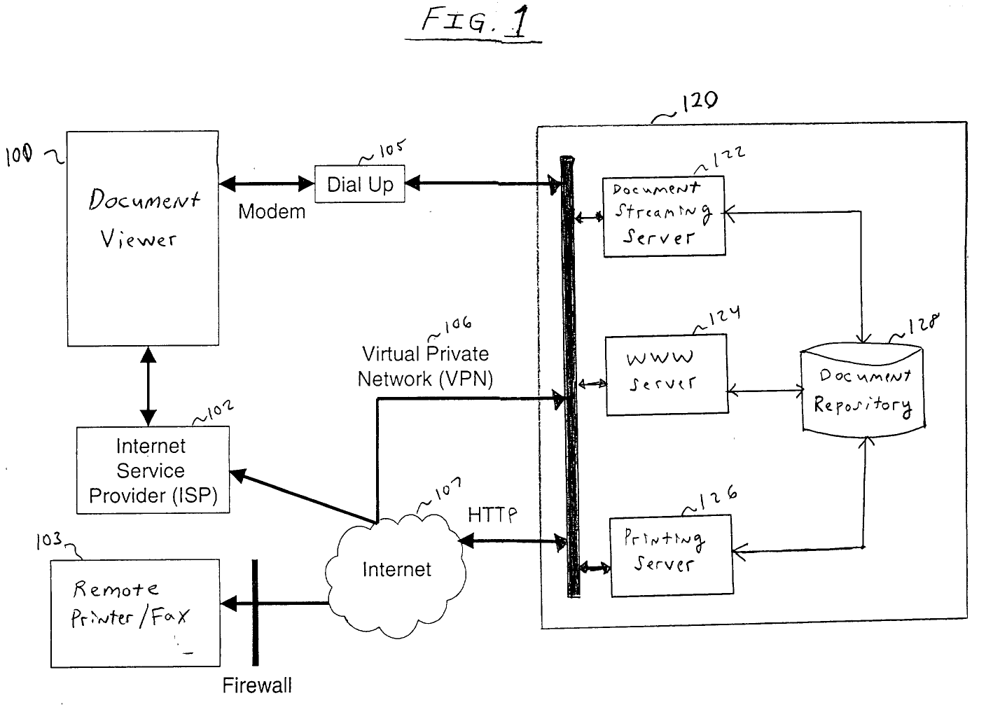

The following will describe the overall system architecture as illustrated in FIG. 1. On the client side, a document viewer 100 communicates with a corporate network 120 through either a modem dial-up connection 105, a virtual private network (VPN) 106, or the Internet 107. Communication via the VPN 106 or the Internet may require the services of an Internet Service Provider (ISP) 102. On the server side, communication with the client may be accomplished by a document streaming server 122, a Worldwide Web (WWW) Server 124, and a Printing Server 126. The document streaming server 122, WWW server 124, and printing server 126 are operatively connected to a document repository 128.

The document viewer 100 is a Web component for mobile devices that enables a user to access and view documents, such as, for example, a Microsoft Office document (e.g., PowerPoint, Word, Excel) with quality and resolution that is close to what is available on the desktop, without the need to download it to a local device. Users may select documents from their private folders in the document repository 128, view a thumbnail of each page of the document, or zoom in and out of each page of the document, and navigate to the previous and next page of the document. The document viewer 100 also allows a user to print or fax the selected documents to any printer residing on the Internet from their mobile device. A list of available printers on the Internet can be presented to the user. The user can select a printer, query the printer status and/or receive notification once printing is finished. The document viewer 100 may also include a Web browser that acts as a container for Web components, and provides the mechanism needed for dynamic installation of the web components when the components are not installed locally.

The document streaming server 122 is a key component on the server side. Once a new connection request is established, the document streaming server 122 then processes the selected document on the fly, on a page-by-page basis, for both a thumbnail view and a requested portion of each original page corresponding to the active viewing area. It may place data into a queue and transfer the data upon request to the active viewing area, and periodically check with client devices to prepare for incoming requests. Additionally, the document streaming server 122 can monitor network traffic, optimize data transmission rates and make decisions as to where or when to remove packet data from the data queue, according to the current condition of the device and network.

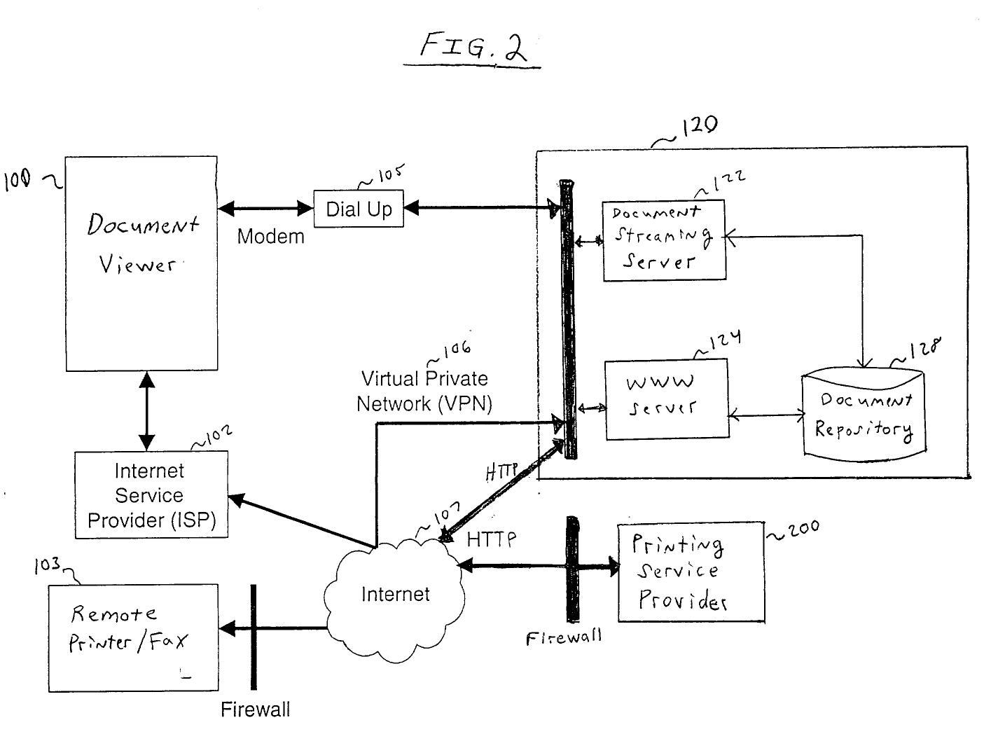

The printing server 126 is an optional off-the-shelf component that is used when Internet printing or faxing is desired. Internet printing/faxing is the process of sending a print data stream directly to a printer/fax machine that is connected to the Internet. The printing server 128 interacts either with the document repository 128 (when it is within a local network 120) or with the WWW server 124 (when it is outside of the corporate network 120 as a service provider, as shown in FIG. 2). In either case, the printing server 126 transfers the selected document to a designated Internet printer upon request. The printer server 126 may use a third party product, which supports Internet printing without requiring the native application be installed on a printing client. In addition, the printing server 126 may support Internet printing/faxing to printers protected by a firewall, since the data stream has to be able to come into a secured network, for example, a hotel network. In any case, the printer must be recognized by the printing server 126 in order to transfer the selected documents to it, which can be achieved by either hosting the printing server or subscribing to a provided service.

The document repository 128 hosts all documents for access by mobile users. Mobile users may view, print, or fax documents contained in the document repository 128. The document repository 128 may include a file system on a local or a network drive, a document server, or a physical repository that requires users to upload documents before use. Documents for each user may be stored in private folders, and authentication may be required for connection to the document repository 128. Both the streaming server 122 and the printing server 126 can interact with the document repository 128 to transfer documents for viewing, printing or faxing purposes.

The Worldwide Web (WWW) server 124 interacts with the client components, and acts as a request router to forward client commands or requests to either the document streaming server 122, the printing server 124, or to obtain relevant information from the document repository 128 to be passed back to a mobile device. The standard hypertext protocol (HTTP) may be used for this purpose, and is also an off-the-shelf component.

In operation, a user interacting with the document viewer 100 may remotely access, view, print or fax documents via the dial-up connection 105, the VPN connection 106, or the Internet connection 107. Users can be challenged to validate their authenticity when first connected to the WWW server 124. Authenticated users may be able to change or set up their own preferences or have default preferences assigned. The preferences may include the addresses of Internet printers, for example.

Once authenticated, users may be presented with options for browsing a list of documents, deleting documents, and selecting documents for viewing, printing, or faxing. When viewing a document is selected, the WWW server 124 routes the request to the document streaming server 128, which thereupon takes over control and communication with the document viewer 100. The WWW server 124 processes other incoming requests. A very similar sequence of actions occurs when printing or faxing a document is selected, except that the printing server 126 takes over control and communication. Optionally, printing- and faxing-related requests may be routed to a printing service provider 200 through the WWW server 124, as shown in FIG. 2.

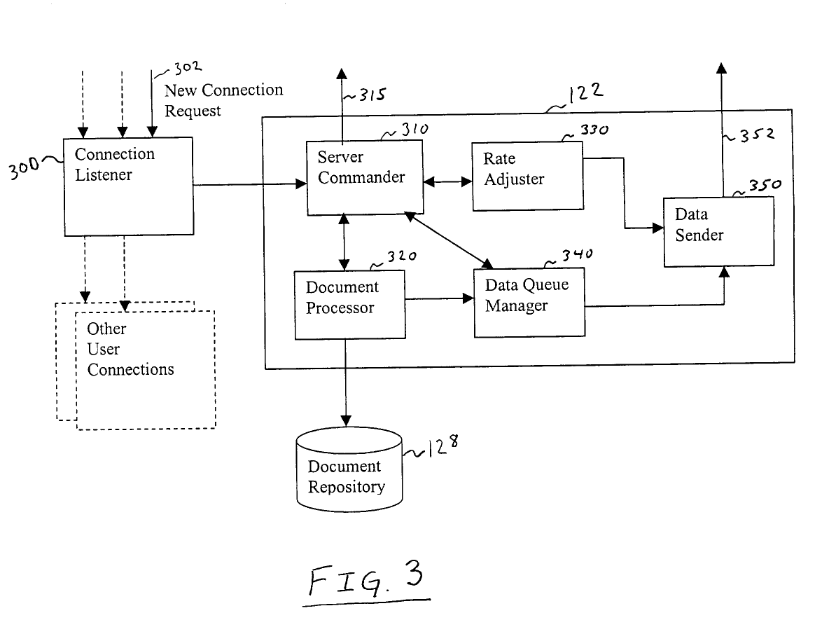

The following will describe the functioning of the document streaming server 122 of FIG. 3. The document streaming server 122 includes a server commander 310, a document processor 320, a rate adjuster 330, a data queue manager 340, and a data sender 350. The server commander 310 is operatively connected to the document processor 320, which, in turn, is operatively connected to the data queue manager 340 and the document repository 128. Additionally, the server commander 122 is operatively connected to the rate adjuster 330, which, in turn, is operatively connected to the data sender 350. The server commander 310 is also operatively connected to the data manager queue, which, in turn, is operatively connected to the data sender 350. A connection listener 300 is operatively connected to the streaming server 122 (specifically, the server commander 310).

In operation, once a new connection request 302 is received by the communication listener 300, a new thread may be started. The communication listener 300 then hands over control to the server commander 310, which informs the document processor 320 to process and parse a particular document from the document repository 128 into segments, and places the necessary data packets that correspond to the active viewing area into a queue in the data queue manager 340 to be transmitted by the data sender 350 via a link 352 to the client. The data transmission ends once the queue in the data queue manager 340 is empty. The data sending rate is controlled by the rate adjuster 330, which can be dynamically adjusted according to client feedback information passed via a link 315 to the server commander 310. At the same time, data packets in the data queue manager 340 may be discarded or removed if the feedback from the client indicates that they will not be needed or that the data cannot arrive in time (e.g., because of network congestion).

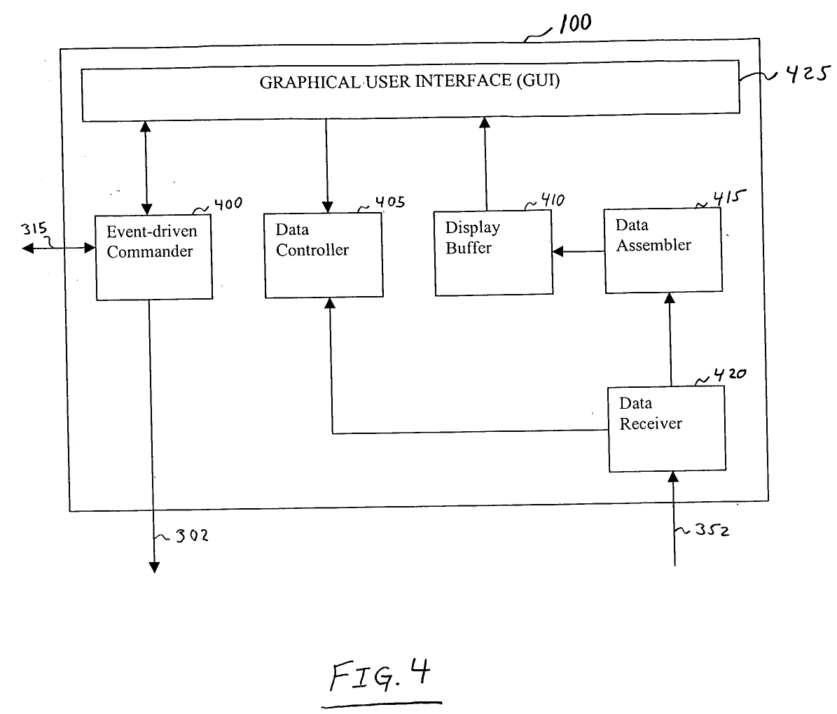

The following will describe the functioning of the document viewer 100 of FIG. 4. The document viewer 100 includes an event-driven commander 400, a data controller 405, a display buffer 410, a data assembler 415, a data receiver 420, and a graphical user interface (GUI) 425. The event-driven commander 400, the data controller 405, and the display buffer 410 are operatively connected to the graphical user interface 425. Additionally, the display buffer 410 is operatively attached to the data assembler, which, in turn, is operatively connected to the data receiver 420. The data receiver 420 is also operatively connected to the data controller 405, and can receive data packets from the document streaming server 122 via a link 352.

The event-driven commander 400 may issue all requests and handle all responses from the document streaming server 122 and the printing server 126. For example, once a viewing command is acknowledged, data packets can be read by the data receiver 420 and passed onto the data assembler 415. The data assembler 415 can decompress and reassemble segments for display in the display buffer 410. Meanwhile, the data controller 405 can monitor all incoming requests and any delays between a particular request and the arrival of corresponding data packets. Further, the data controller 405 can make decisions on whether the data in the display buffer 410 is to be displayed or discarded. In addition, the event-driven commander 400 may be aware of such decisions, and can inform the streaming server 122, if necessary.

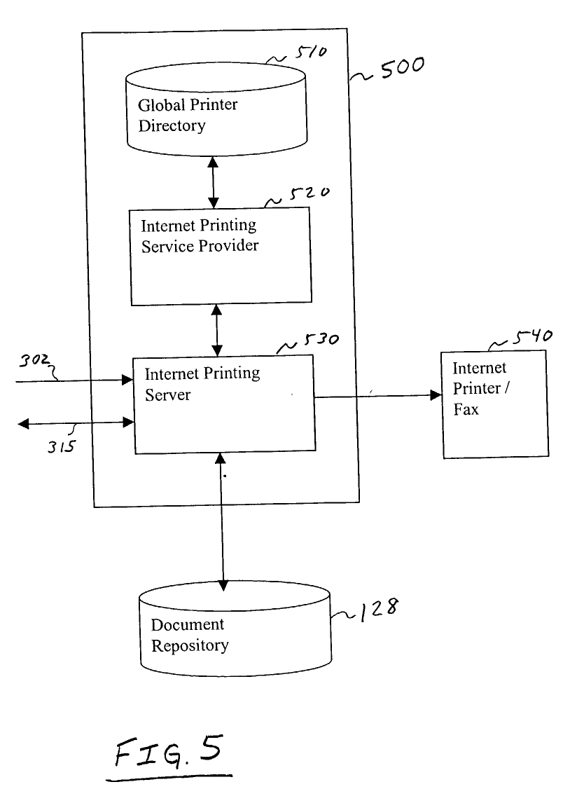

The following will describe the integration of a third-party printing service with an embodiment of the present invention, as illustrated in FIG. 5. A printing service 500 includes a global printing directory 510, an Internet Printing Service Provider 520, and an Internet printing server 530. The Internet printing service provider 520 is operatively connected to the global printer directory 510 and the Internet printing server 530. The Internet printing server is also operatively connected to an Internet printer/fax device 540 and to the document repository 128.

Once printing or faxing of a document is issued, the event driven commander 400 can be directed to the Internet printer server 530, which may communicate with the Internet printing service provider 520, and, in turn, with the global printer directory 540, to validate the default Internet printer/fax, or return a list of available devices to the user. Once a printer or fax device is selected or the default one is validated, the Internet printing server 530 may fetch the requested document from the document repository 128, and sends the requested document to the Internet printer/fax 540. The printer/fax status or notification may be sent to the user through the event driven commander 400,

It is to be understood that the present invention may be implemented in various forms of hardware, software, firmware, special purpose processors, or a combination thereof. Preferably, the method steps of the present invention are implemented in software as a program tangibly embodied on a program storage device. The program may be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein may either be part of the microinstruction code or part of the program (or combination thereof) which is executed via the operating system. In addition, various other peripheral devices may be connected to the computer platform such as an additional data storage device and a printing device.

It is to be understood that, because some of the constituent system components and method steps depicted in the accompanying figures are preferably implemented in software, the actual connections between the system components (or the process steps) may differ depending upon the manner in which the present invention is programmed.

Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

What is claimed is:

1. A method for remotely accessing documents stored in a document repository, comprising the steps of:
requesting a list of documents from the document repository;
presenting the list of documents;
selecting a document from the presented list; and
receiving streamed data corresponding to specified portions of the selected document, in response to client requests.

2. The method of claim 1, further including the steps of:
specifying portions of the selected document to be received; and
requesting the specified portions from a server.

3. The method of claim 2, wherein specifying portions of the selected document is accomplished using one or more of a stylus, a hand tool, a scroll bar, a pointing device, a zooming tool, and page selection.

4. The method of claim 1, further comprising displaying the specified portions of the selected document on a client device.

5. The method of claim 4, wherein the displayed portions of the selected document retain the look and feel of corresponding portions of a document stored in the document repository.

6. The method of claim 4, wherein at least some of the displayed portions of the selected document were previously displayed.

7. The method of claim 1, wherein documents in the document repository are stored as private folders on a server.

8. The method of claim 1, wherein documents in the presented list each includes an identifier.

9. The method of claim 1, wherein the presented list includes thumbnails.

10. The method of claim 1, wherein the selected document is of any size.

11. The method of claim 4, wherein the client device is a mobile device.

12. The method of claim 11, wherein the mobile device is a Personal Digital Assistant (PDA).

13. The method of claim 11, wherein the mobile device is connected to a network via a dial-up modem.

14. The method of claim 11, wherein the mobile device is connected to a wireless network.

15. The method of claim 1, further comprising the steps of:
receiving a request to provide a hard copy of a document stored in the document repository to a selected output device; and
sending the requested document to the selected output device.

16. The method of claim 15 wherein the selected output device is one of a facsimile (fax) machine and a printer.

17. The method of claim 15, wherein the output device is provided by a third party service provider via the Internet.

18. The method of claim 1, further comprising the steps of:
receiving a request to change the status of a document stored in the document repository; and
changing the status of the document stored in the document repository, in accordance with the requested status change.

19. The method of claim 18, wherein the status is changed to either approved or disapproved.

20. A method for streaming document portions on demand to a client device, comprising the steps of:
determining a current active window for a client device;
obtaining a specified portion of a selected document corresponding to the active window;
sending streamed data corresponding to the specified portion of the selected document to the client device; and
repeating the above steps, responsive to client requests.

21. The method of claim 20, further comprising placing information from a document repository expected to be requested by the client into a data queue.

22. The method of claim 21, wherein the specified portion of the selected document includes information obtained from the data queue

23. The method of claim 21, further comprising removing data from the data queue that is no longer expected to be used.

24. The method of claim 20, wherein the specified portion of the selected document is specified using one or more of a stylus, a hand tool, a scroll bar, a pointing device, a zooming tool, and page selection.

25. The method of claim 20, further comprising displaying the specified portion of the selected document on a client device.

26. A program storage device readable by a machine, tangibly embodying a program of instructions executable on the machine to perform method steps for remotely accessing documents stored in a document repository, comprising the method steps of:
requesting a list of documents from the document repository;
presenting the list of documents to a user;
selecting a document from the presented list; and
receiving streamed data corresponding to specified portions of the selected document, in response to client requests.

27. A program storage device readable by a machine, tangibly embodying a program of instructions executable on the machine to perform method steps for streaming document portions on demand to a client device, comprising the method steps of:
determining a current active window for a client device;
obtaining a portion of the selected document corresponding to the active window;
sending streamed data corresponding to the portion of the selected document to the client device; and
repeating the above steps, responsive to client requests.
